(19) United States
(12) Patent Application Publication
(10) Pub. No.: US 2013/0052053 A1
(43) Pub. Date: Feb. 28, 2013

(54) AIR CYCLE MACHINE TIE ROD

(71) Applicants: Darryl A. Colson, West Suffield, CT (US); Craig M. Beers, Wethersfield, CT (US)

(72) Inventors: Darryl A. Colson, West Suffield, CT (US); Craig M. Beers, Wethersfield, CT (US)

(21) Appl. No.: 13/220,598

(22) Filed: Aug. 29, 2011

(51) Int. Cl. F04D 13/04; B23P 11/00; F04D 29/044

(52) U.S. Cl. 417/406; 464/179; 29/888.024

(57) ABSTRACT

An exemplary shaft assembly of an air cycle machine includes a cylindrical body rotatably coupling a compressor rotor, a turbine rotor and a fan rotor. The cylindrical body has an axial length and a diameter. A ratio of the axial length to the diameter is from 34.82 to 35.18.

### BACKGROUND

This disclosure relates to a tie rod for an air cycle machine that supplies air to, for example, an aircraft cabin.

Known air cycle machines include a turbine rotor that rotatably drives a compressor rotor via a shaft assembly. The air cycle machine houses the turbine rotor in a turbine section and houses the compressor rotor in a compressor section. Bearings rotatably support the shaft assembly during rotation.

The shaft assembly includes a tie rod received within a journal shaft. The tie rod clamps together the shaft assembly, the turbine rotor, the compressor rotor, etc. Relatively high clamping forces are used to encourage the various components to rotate together with the shaft assembly as a single rotating unit. The dimensions of the tie rod are typically based on the desired clamping forces and desired clearances to other components.

During operation, resonance causes some tie rods, rotating at typical operating speeds, to become unbalanced and undesirably vibrate.

### SUMMARY

An exemplary shaft assembly of an air cycle machine includes a cylindrical body rotatably coupling a compressor rotor, a turbine rotor, and a fan rotor. The cylindrical body has an axial length and a diameter. A ratio of the axial length to the diameter is from 34.82 to 35.18.

An exemplary air cycle machine includes a compressor section having a compressor rotor and a turbine section having a turbine rotor. A shaft assembly rotatably couples the compressor rotor to the turbine rotor. A tie rod of the shaft assembly has a length and a diameter. The ratio of the length to the diameter is from 34.82 to 35.18.

An exemplary method of installing a tie rod in an air cycle machine includes providing a cylindrical body that rotatably couples at least one of a compressor rotor, a turbine rotor, and a fan rotor. The cylindrical body has a primary portion positioned axially between a first and a second connection portion. The primary portion has an axial length and a diameter. A ratio of the axial length of the primary portion to the diameter of the primary portion is from 28.42 and 28.98. The method includes positioning the cylindrical body within a journal shaft. The method also includes securing a clamping member to the first connection portion, the second connection portion, or both, to secure the compressor rotor, the turbine rotor, and the fan rotor relative to the cylindrical body.

An exemplary tie rod assembly for an air cycle machine includes a cylindrical body rotatably coupling a compressor rotor, a turbine rotor, and a fan rotor. The cylindrical body has an axial length and a diameter. A ratio of the axial length to the diameter is from 34.82 to 35.18.

### DESCRIPTION OF THE FIGURES

The various features and advantages of the disclosed examples will become apparent to those skilled in the art from the detailed description. The figures that accompany the detailed description can be briefly described as follows:

FIG. 1 shows a section view of an example air cycle machine that supplies air.

FIG. 2 is a perspective view of a rotatable assembly used within the FIG. 1 air cycle machine.

FIG. 3 is a section view at line 3-3 in FIG. 2.

FIG. 4 shows a side view of a tie rod of the FIG. 1 air cycle machine.

FIG. 5 shows a section view at line 5-5 in FIG. 4.

### DETAILED DESCRIPTION

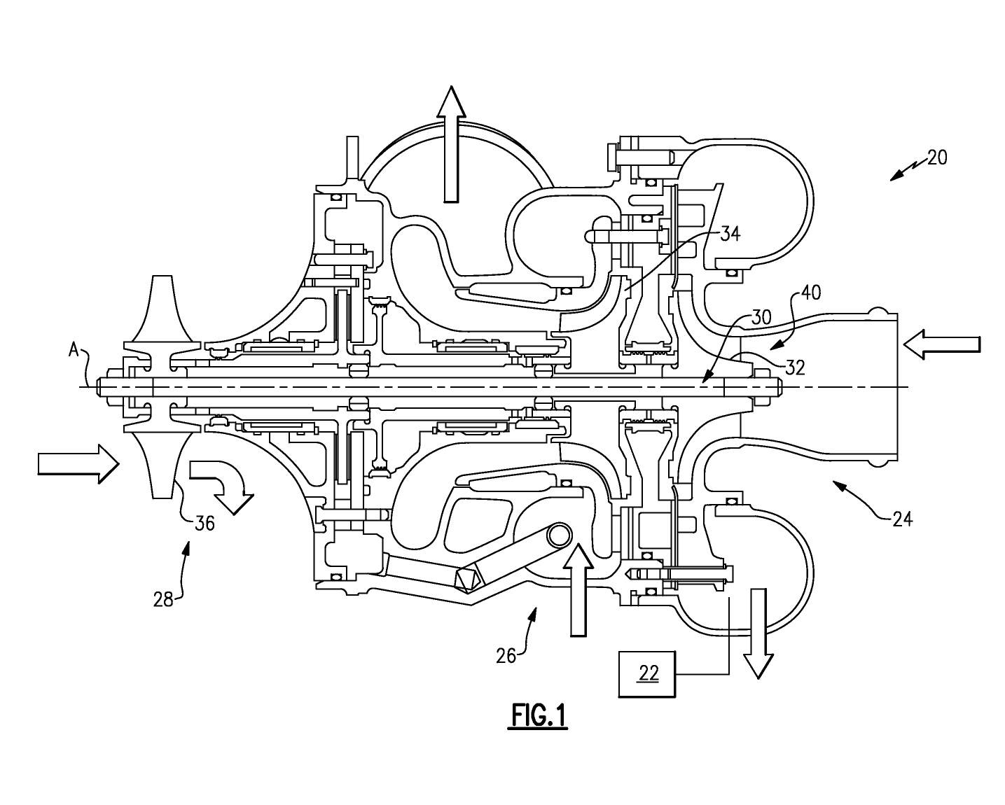

FIG. 1 shows an example air cycle machine 20 (“ACM”) that is incorporated into an air supply system 22 of a vehicle, such as an aircraft, helicopter, or land-based vehicle. In this example, ACM 20 supplies air to an aircraft cabin.

The example ACM 20 includes a compressor section 24, a turbine section 26, and a fan section 28. A main shaft assembly 30 extends along an axis A through the sections. Air bearings may support the example main shaft assembly 30.

The compressor section 24 includes a compressor rotor 32. The turbine section 26 includes a turbine rotor 34. The fan section 28 includes a fan rotor 36. The compressor rotor 32, the turbine rotor 34, and the fan rotor 36 rotate together with the main shaft assembly 30 about the axis A. Together, the compressor rotor 32, the turbine rotor 34, the fan rotor 36, and the shaft assembly 30 establish a rotative assembly 40 of the ACM 20.

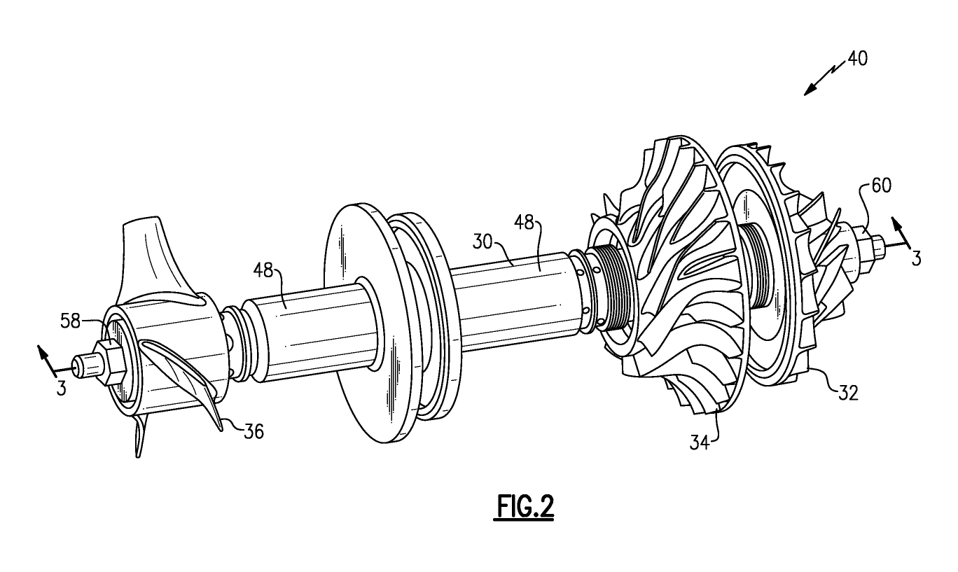

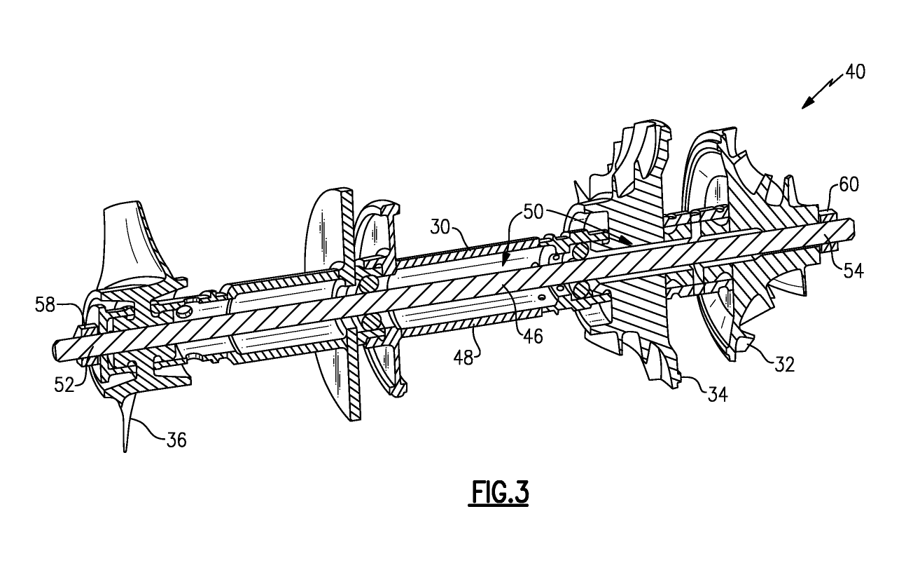

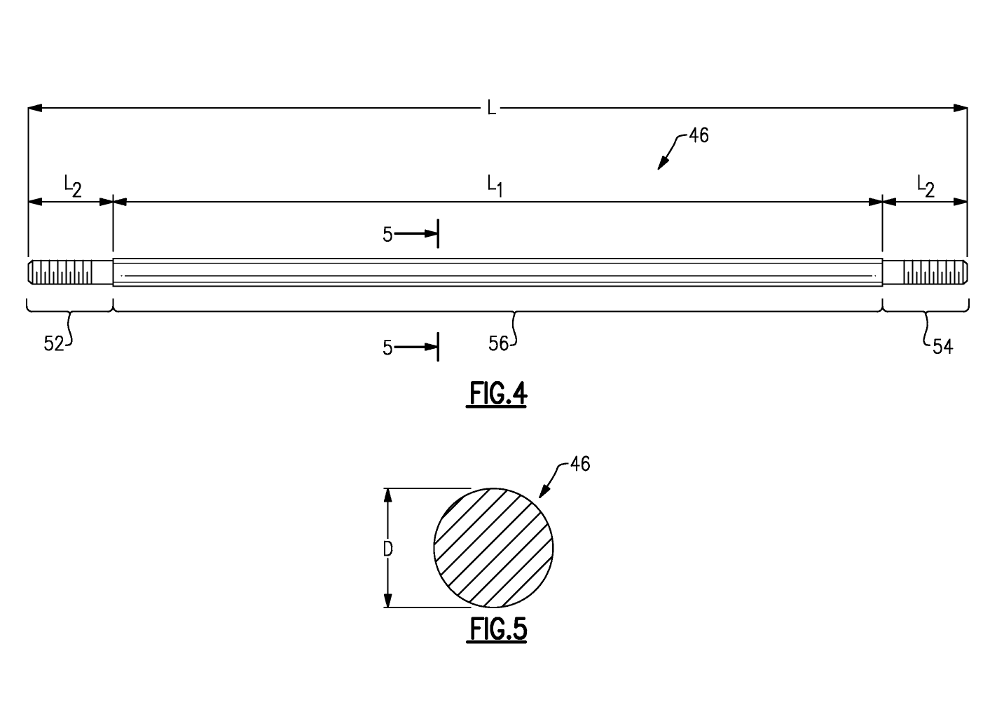

Referring now to FIGS. 2-5 with continuing references to FIG. 1, the example shaft assembly 30 includes a tie rod 46. Portions of the tie rod 46 are received within journal shafts 48. Other portions of the tie rod 46 are received within bores of the compressor rotor 32, the turbine rotor 34, the fan rotor 36, etc.

The shaft assembly 30 defines an annular flow path 50 radially outboard from the tie rod 46. During operation, air communicates along the annular flow path 50 to cool the bearings that rotatably support the shaft assembly 30.

In this example, the annular flow path 50 does not extend axially past the fan rotor 36 or the compressor rotor 32. There is very little radial clearance between the tie rod 46 and the fan rotor 36, or the tie rod 46 and the compressor 32, which prevents air within the annular flow path 50 from moving into these areas.

The example tie rod 46 includes first and second connection portions 52 and 54, and a primary portion 56. The primary portion 56 is located axially between the first and second connection portions 52 and 54.

In this example, some areas of the first and second connection portions 52 and 54 include threads. Connection members, such as nuts 58 and 60, are secured to the first and second connection portions 52 and 54, respectively.

In this example, the nuts 58 and 60 are tightened to axially clamp the compressor rotor 32, the turbine rotor 34, the fan rotor 36 and the journal shafts 48. The clamping load holds these components during operation of the ACM 20. The clamping load causes the shaft assembly 30, the turbine rotor 34, the compressor rotor 32, etc., to rotate together as the rotative assembly 40 of the ACM 20.

The connection portions 52 and 54 differ from the primary portion 56 because the connection portions 52 and 54 are used to connect the tie rod 46 to the remaining portions of the shaft assembly 30, and the primary portion 56 is not.

A maximum rotating speed for the rotative assembly 40 of the example ACM 20 during typical operation is about 82,000 rotations per minute. 100,000 rotations per minute is an absolute maximum rotational speed for the example ACM 20. The ACM 20 rotates at other speeds and has a different absolute maximum rotation speed in other examples.

The example tie rod 46 has a total length L. In this example, the total length L is 9.450 inches (24.003 centimeters)±0.030 inches (0.076 centimeters). In this example, a length L₁ of primary portion 56 varies from 7.69 inches (19.532 centimeters) to 7.81 inches (19.837 centimeters). The first and second connection portions 52 and 54 each have a length L₂ that is 0.850 inches (2.160 centimeters)±0.015 inches (0.0381 centimeters).

Also, in this example, the diameter D of the primary portion 56 is 0.2700 inches (0.6858 centimeters)±0.0005 inches (0.0013 centimeters). The diameter D of the primary portion 56 may be even more tightly controlled in some areas, such as near the fan rotor 36 and the compressor rotor 32, due to the relatively tight clearance to these components. The diameter of the connection portions 52 and 54 is typically less than the diameter D.

The ratio of the total length L to the diameter D is controlled in the example tie rod 46. Maintaining the ratio of the length L to the diameter D within a particular range prevents the tie rod 46 from entering a resident mode during operation of the ACM 20. The resident mode is a function of the length and diameter of a cylinder.

In this example, the ratio of the total length L to the diameter D of the primary portion 56 is from 34.82 and 35.18. Also, the ratio of the mid-portion length L₁ to the diameter of the primary portion 56 is from 28.42 and 28.98.

The preceding description is exemplary rather than limiting in nature. Variations and modifications to the disclosed examples may become apparent to those skilled in the art that do not necessarily depart from the essence of this disclosure. Thus, the scope of legal protection given to this disclosure can only be determined by studying the following claims.

We claim:

1. A shaft assembly of an air cycle machine, comprising:
a cylindrical body rotatably coupling a compressor rotor, a turbine rotor, and a fan rotor, the cylindrical body having an axial length and a diameter, wherein a ratio of the axial length to the diameter is from 34.82 to 35.18.

2. The shaft assembly of claim 1, wherein the cylindrical body includes first and second connection portions, and a primary portion located axially between the first and second connection portions, wherein the diameter is a diameter of the primary portion.

3. The shaft assembly of claim 2, wherein the first and second connection portions are threaded.

4. The shaft assembly of claim 2, wherein the first and second connection portions have a second diameter that is less than the diameter of the primary portion.

5. The shaft assembly of claim 2, wherein a ratio of an axial length of the primary portion to the diameter of the primary portion is from 28.42 to 28.98.

6. The shaft assembly of claim 2, wherein the first and second connection portions are threaded.

7. The shaft assembly of claim 1, wherein the cylindrical body is received within cylindrical housing, and an annular flow path is established between the cylindrical body and the cylindrical housing.

8. An air cycle machine, comprising:
a compressor section having a compressor rotor;
a turbine section having a turbine rotor; and
a shaft assembly rotatably coupling the compressor rotor to the turbine rotor, wherein a tie rod of the shaft assembly has a length and a diameter, and the ratio of the length to the diameter is from 34.82 to 35.18.

9. The air cycle machine of claim 8, wherein the air cycle machine supplies air to a cabin of an aircraft.

10. The air cycle machine of claim 8, wherein the length is a total length and the diameter is a diameter of a primary portion of the shaft assembly.

11. The air cycle machine of claim 10, wherein a ratio of an axial length of the primary portion to the diameter of the primary portion is from 28.42 to 28.98.

12. The air cycle machine of claim 8, wherein the shaft assembly further includes a journal shaft and the tie rod is received within the journal shaft.

13. The air cycle machine of claim 8, including clamping members secured to a first and second connection portion of the tie rod, the clamping members applying a load to secure the compressor rotor and the turbine rotor relative to the tie rod.

14. A method of installing a tie rod in an air cycle machine, comprising:
(a) providing a cylindrical body rotatably coupling at least one of a compressor rotor, a turbine rotor and a fan rotor, the cylindrical body having primary portion positioned axially between a first and second connection portions, the primary portion having an axial length and a diameter, wherein a ratio of an axial length of the primary portion to the diameter of the primary portion is from 28.42 and 28.98;
(b) positioning the cylindrical body within a journal shaft;
(c) securing a clamping member to the first connection portion, the second connection portion, or both, to secure the compressor rotor, the turbine rotor, the fan rotor, or some combination of these, relative to the cylindrical body.

15. The method of claim 14, wherein a ratio of a total axial length of the cylindrical body to a diameter of the primary portion is from 34.82 to 35.18.

16. A tie rod assembly for an air cycle machine comprising:
a cylindrical body rotatably coupling a compressor rotor, a turbine rotor, and a fan rotor, the cylindrical body having an axial length and a diameter, wherein a ratio of the axial length to the diameter is from 34.82 to 35.18.

17. The tie rod assembly of claim 16, wherein a ratio of an axial length of the primary portion to the diameter of the primary portion is from 28.42 to 28.98.

18. The tie rod assembly of claim 16, wherein the cylindrical body includes first and second connection portions, and a primary portion located axially between the first and second connection portions, wherein the diameter is a diameter of the primary portion.
